(19) United States
(12) Patent Application Publication
(10) Pub. No.: US 2023/0415510 A1
(43) Pub. Date: Dec. 28, 2023

(54) DEVICE AND METHOD FOR OPTIMIZING THE GRIP OF A TIRE FITTED TO A MOBILE VEHICLE TRAVELING ON A ROAD SURFACE, AND MOTOR VEHICLES AND AIRCRAFT INCORPORATING SUCH A DEVICE

(71) Applicant: Dryside, Rouen (FR)

(72) Inventor: Jean-Baptiste Roger, Rouen (FR)

(21) Appl. No.: 18/250,703

(22) PCT Filed: Oct. 21, 2021
(86) PCT No.: PCT/FR2021/051848

§ 371 Date: Apr. 26, 2023

(30) Foreign Application Priority Data
Oct. 26, 2020 (FR) FR2010954
Oct. 21, 2021 (FR) FR2111179

(51) Int. Cl. B60B 39/10; B60B 39/02; G06V 20/56

(52) U.S. Cl. CPC B60B 39/10; B60B 39/025; G06V 20/588

(57) ABSTRACT

A device for improving the grip of a tire fitted to a mobile vehicle traveling on a road surface, this device being on board the mobile vehicle and comprising:
means for detecting and characterizing the presence of water on the road surface in front of the mobile vehicle,
means for processing information received from the detection and characterization means and for generating control instructions, and
means for emitting a power laser beam directed toward a portion of road surface in front of a tire of the mobile vehicle, which means are designed to vaporize or sublimate the water present in front of the tire in response to control instructions. The device is used, in particular, for motor vehicles and aircraft.

### CROSS-REFERENCE TO RELATED APPLICATIONS

This application is a national phase entry under 35 U.S.C. § 371 of International Patent Application PCT/FR2021/051848, filed Oct. 21, 2021, designating the United States of America and published as International Patent Publication WO 2022/090649 A1 on May 5, 2022, which claims the benefit under Article 8 of the Patent Cooperation Treaty to French Patent Application Serial No. FR2010954, filed Oct. 26, 2020 and to French Patent Application Serial No. FR2111179, filed Oct. 21, 2021.

### TECHNICAL FIELD

The present disclosure relates to a device for optimizing the grip of a tire fitted to a mobile vehicle traveling on a road surface. It also relates to a method for optimizing the grip implemented in this device, as well as motor vehicles and aircraft incorporating such a device.

The road surfaces concerned may be wet, cold, snowy or icy ground or any other variant whose disrupting element present on the grip surface can be vaporized or diverted. The transport sectors targeted include automotive sectors as well as those of civil and military aeronautics or any sectors using traveling vehicles equipped with tires. The device also has an advantage in improving the performance of a vehicle, in particular, in motor sport and when striving for high-performance.

### BACKGROUND

Safety systems are already available such as ABS, ESP or EBA in the context of a braking phase. ABS, or anti-lock braking system, prevents the wheels from locking and enables steering control to be maintained in the case of emergency braking. ESP, or electronic stability program, is a trajectory correction device in the event of loss of grip. Finally, EBA (for Emergency Brake Assist) is, just like ABS, particularly interesting within the scope of the present disclosure. This emergency brake assist detects the abnormally fast switch from the accelerator pedal to the brake pedal. It should be noted that these driving aids are practically absent from the world of motor racing.

Regarding acceleration phases, the prior art are methods aimed at reducing the power transmitted to the wheels in order to regain grip; Traction Control (TC) is an example.

The effectiveness of emergency braking or a sudden acceleration on wet road is, non-exhaustively, directly related to the tire used (type of rubber, wear, temperature, inflation pressure), to the quantity of water present on the bitumen and to its temperature, to the desired braking or acceleration power and to the electronic grip control system.

Methods have existed with the aim of removing the water present on the road surface upstream of the tire, in particular, using jets of compressed air. However, these inventions have not come to fruition in the automotive industry even though the experimental results on a compressed air system saw in excess of a 20% reduction in braking distances up to 90 km/h. This compressed air system was activated by a windshield wiper and embedded in DC fans housed in the wheel arches.

The objective of the present disclosure is to contribute to increasing the grip coefficient of a tire fitted to a mobile vehicle, by using a laser beam to vaporize the element limiting the grip on the road surface, both in a braking and acceleration phase.

### BRIEF SUMMARY

This objective is achieved with a device for optimizing the grip of a tire fitted to a mobile vehicle traveling on a road, this device being on board the mobile vehicle and comprising:
means for detecting and characterizing the presence of water on the road surface in front of the mobile vehicle,
means for processing information received from the detection and characterization means and for generating control instructions, and
means for emitting a high-power laser beam directed toward a portion of road surface in front of at least one tire fitted to the mobile vehicle, which means are designed to vaporize or sublimate the water present in front of the at least one tire in response to control instructions.

The device according to the present disclosure thus aims to increase the grip performance of a tire fitted to a vehicle traveling on wet ground, during braking and acceleration phases. It also relates to cold, snowy or icy ground or any other variant whose disrupting element present on the grip surface can be vaporized using a laser. It is conceivable to apply the device to automotive sectors as well as to civil and military aeronautics or any other traveling vehicle.

The main role of the grip optimization device is to increase the grip coefficient of the tire by vaporizing and/or deflecting the water present on the road surface, in any form whatsoever. However, the present disclosure is not only limited to water (in any state whatsoever) but also to any other liquid capable of being diverted or vaporized in front of a tire.

The present disclosure has the advantage of increasing the grip without reducing performance during acceleration. This aspect is particularly advantageous in a motor racing setting or when striving for high-performance.

The processing and control means are preferably arranged to further process information received from at least one braking safety system fitted to the mobile vehicle.

The detection and characterization means can advantageously comprise a camera having an image-capture field directed toward a portion of road surface in front of the mobile vehicle.

These detection and characterization means may further comprise means for measuring or estimating the external temperature in the vicinity of the road.

The means for emitting a laser beam may comprise a laser optical module arranged under the mobile vehicle and arranged so as to project the laser beam onto a portion of road surface in front of a tire of the vehicle.

The means for emitting a laser beam can further comprise a laser source module controlled by the processing and control means and connected to the optical module by optical fiber means.

In a particular embodiment, the grip optimization device may further comprise means for cooling the laser source module. These cooling means may comprise a heat transfer fluid circuit.

The laser optical module can be arranged to scan a laser beam over the road surface according to a predetermined scanning trajectory.

The braking safety system can comprise an anti-lock braking system (ABS), an emergency braking assist system (EBA), or an electronic stability program (ESP).

The control and processing means can be connected to an electronic control unit (ECU) on the vehicle.

When the grip optimization device according to the present disclosure is implemented in a vehicle comprising a body to which the means for emitting the laser beam are attached, it can further comprise means for detecting body movement and for transmitting detection information to the control and processing means.

According to another aspect of the present disclosure, a method is proposed for optimizing the grip of a tire fitted to a mobile vehicle traveling on a road surface, comprising:
a step for detecting and characterizing the presence of water on the road surface in front of the mobile vehicle,
a step for transmitting information for detecting and characterizing the presence of water on the road surface,
a step for processing the detection and characterization information to generate control instructions, and
a step for emitting a power laser beam directed toward a portion of road surface in front of at least one tire fitted to the mobile vehicle, so as to vaporize or sublimate the water present in front of the at least one tire in response to control instructions.

The method according to the present disclosure can further comprise a step for processing information received from at least one braking safety system fitted to the mobile vehicle.

The detection and characterization step can use a camera having an image-capture field directed toward a portion of road surface in front of the mobile vehicle.

The detection and characterization step may further comprise a measurement or an estimation of the external temperature in the vicinity of the road.

According to yet another aspect of the present disclosure, a motor vehicle is proposed incorporating a grip optimization device according to the present disclosure, this motor vehicle comprising:
means for detecting and characterizing the presence of water on a road surface in front of the motor vehicle,
means for processing information received from the detection and characterization means and for generating control instructions, and
means for emitting a power laser beam directed toward a portion of road surface in front of at least one tire fitted to the motor vehicle, these emission means being arranged in the front bumper of the vehicle.

According to yet another aspect of the present disclosure, an aircraft is proposed incorporating a grip optimization device according to the present disclosure, this aircraft comprising:
means for detecting and characterizing the presence of water on an airstrip in front of the aircraft when traveling on the airstrip,
means for processing information received from the detection and characterization means and for generating control instructions, and
means for emitting a power laser beam directed toward a portion of airstrip in front of at least one tire of a landing gear fitted to the aircraft, these emission means being arranged on the landing strip.

The main role of the grip optimization device is to increase the grip coefficient of the tire by using a laser beam to vaporize the water present on the road surface, in any form whatsoever. However, the present disclosure is not only limited to water.

Water can be in different physical states: rain, snow, ice; only the optical absorption coefficient will vary, the vaporization energy necessary is therefore directly related to the physical state of the water to be vaporized. Studying the water absorption coefficient (in cm⁻¹) determines the wavelength of the laser to be used. The power will be dependent on the tire width, the vehicle speed, the ambient temperature and the quantity of water present on the road surface.

The present disclosure implements an electronically controlled laser source, from which exits a laser beam transmitted via optical fiber (transmission beam) to an optical module to obtain the effective laser beam. The data necessary for triggering the system is acquired by different sensors (cameras, thermometers, etc.) and via a connection to the ECU (Electronic Control Unit, an on-board system for controlling physical devices inside the vehicle) that can provide the information to activate existing grip control systems and thus cause the device to activate.

For safety reasons, any impact suffered by the vehicle must absolutely disconnect the device in order to prevent any risk to surrounding users.

In another version of the present disclosure, the laser source can be supplemented by a second system dedicated to deflecting a portion of the liquid water. This tandem system can implement a second remote action: high-pressure air jet, supersonic air jet, microwave cannon or any other technical solution that could remotely divert the disrupting element on the road surface upstream of the laser beam. This other version may equally well relate to motor vehicles as to aircraft.

The advantage of the deflection/ablation tandem lies in the possibility of making the device effective under harsher conditions, in particular, at higher speeds and/or if the quantity of water is high.

Since the grip optimization device according to the present disclosure generates heat, an efficient cooling system can be provided in order to guarantee optimal operating conditions. This cooling system can be independent of the cooling system of the vehicle.

The laser beam may have different effects, in particular, that of creating a plasma. Since instantaneous laser ablation of water is energy-consuming, an envisaged alternative with an ablation effect is the creation of a plasma so as to divert the water present in front of the tire, using a laser beam. The creation of a deflection shock wave is also envisaged to move the water away from the tire.

### BRIEF DESCRIPTION OF THE DRAWINGS

Other advantages and particularities of the present disclosure will become apparent on reading the detailed description of implementations and embodiments that are in no way exhaustive, and the following appended drawings:

FIG. 1 is a block diagram of the device applicable to any traveling vehicle, in a first version in a servo-controlled ablation mode.

FIG. 2 is an example of the device applied to a motor vehicle traveling on a wet road.

FIG. 3 is a curve showing the relationship between the wavelength (in m) of a light beam and the absorption (in m⁻¹) of this wave by the water.

FIG. 4 is a block diagram of a specific version of the grip optimization device according to the present disclosure, in servo-controlled tandem mode, implementing a water deflection system.

FIG. 5 shows the operating mode of the version of the grip optimization device illustrated in FIG. 4.

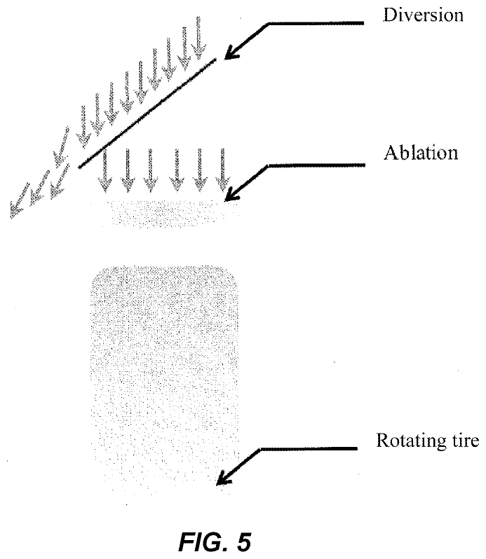

### DETAILED DESCRIPTION

Since these embodiments are in no way limiting, it will particularly be possible to consider variants of the present disclosure comprising only a selection of the features described or illustrated, subsequently isolated from the other features described or illustrated (even if this selection is isolated within a phase comprising other features), if this selection of characteristics is sufficient to confer a technical advantage or to differentiate the present disclosure from the prior art. This selection comprises at least one feature, preferably functional, without structural details, and/or with only a portion of the structural details if this portion alone is sufficient to confer a technical advantage or to differentiate the present disclosure from the prior art.

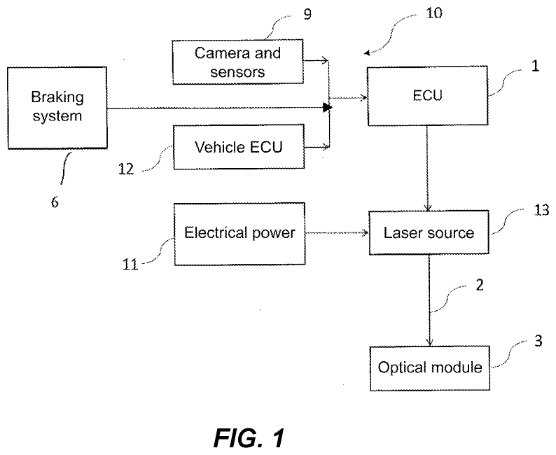

With reference to FIG. 1, the grip optimization device 10 according to the present disclosure comprises a control and processing unit (ECU) 1 receiving as input information for detecting the presence of water and characterizing this water from a camera and sensors 9, the information being transmitted by the electronic control unit (ECU) 12 of the vehicle, and information on the braking conditions emitted by the braking system 6.

The control and processing unit 1 controls a laser source module 13 that is supplied by an electrical power unit 11. This laser source module 13 emits a laser beam that is transmitted via an optical fiber 2 to an optical module 3 arranged in the bumper of the vehicle thus equipped and intended to direct a laser beam toward a portion of road surface upon the command of the control and processing unit 1.

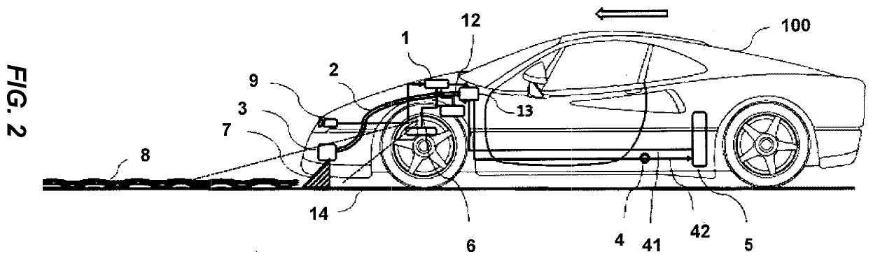

With reference to FIG. 2 and in the context of the device applying to a motor vehicle 100 and for the purpose of optimizing braking, the electronic control unit 1 can advantageously be housed in the engine bay; the wheels receiving the device according to the present disclosure will be the front wheels. The transmission laser beam is transferred by an optical fiber 2 to the bumper where the optical module 3 emitting the effective beam 7 is housed. This optical module 3 contains a lens block.

The laser source module 13 is cooled by a heat transfer fluid circuit comprising hydraulic pipes 41,42, a hydraulic pump 4 and a ventilated cooling radiator 5.

The effective laser beam 7 can vary in shape: it can thus be linear and parallel to the leading edge of the tire or else angled or else in the shape of a “V,” sine wave or any other shape that will enable its effectiveness to be optimized.

Then, in order to optimize the effectiveness of the laser beam on the ground, the focal distance between the lens block and the ground must remain within a low tolerance range. Indeed, the device according to the present disclosure can include feedback control of the focal distance as a function of the body movements. A braking phase will result in a movement where the front of the vehicle will lower a few centimeters; in contrast, an acceleration phase will lower the rear of the vehicle. It is then conceivable to apprehend the body movements in order to have a usable beam within its efficiency range.

As soon as the grip optimization device 10 is activated, a power current must be available very quickly from an electrical power unit 11 on board the vehicle. Depending on the type of vehicle, whether a combustion, electric or hybrid engine, the available current may be redirected from the auxiliary functions (on-board computer, Hi-Fi, comfort components) to the safety device 10.

Water can be in different physical states: rain, snow, ice; the vaporization energy necessary is therefore directly related to the physical state of the water to be vaporized. Studying the water absorption coefficient (in cm-1) determines the wavelength of the laser to be used.

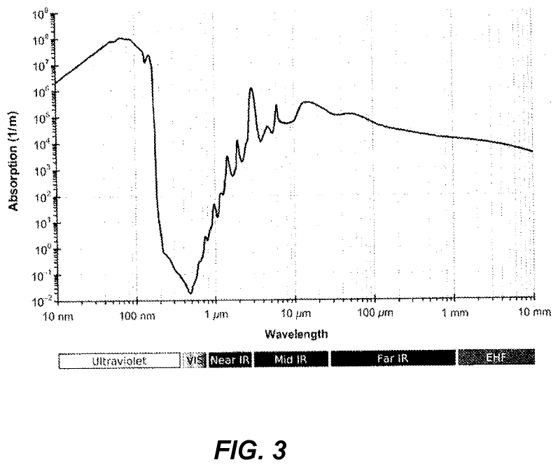

With reference to FIG. 3, which illustrates the relationship between the wavelength of a light beam and the absorption of this wave by the water, it is possible to refine the choice of laser technology to be used. Erbium laser: In particular, YAG emits a beam with a wavelength of 2.9 μm, which corresponds to a water absorption peak in the infrared invisible range. In addition, this type of laser emits a beam that can be easily transported via optical fiber, which is a significant advantage for the embeddability of the device.

The optical power required will be dependent on the tire width, vehicle speed, ambient temperature and amount of water present on the road surface.

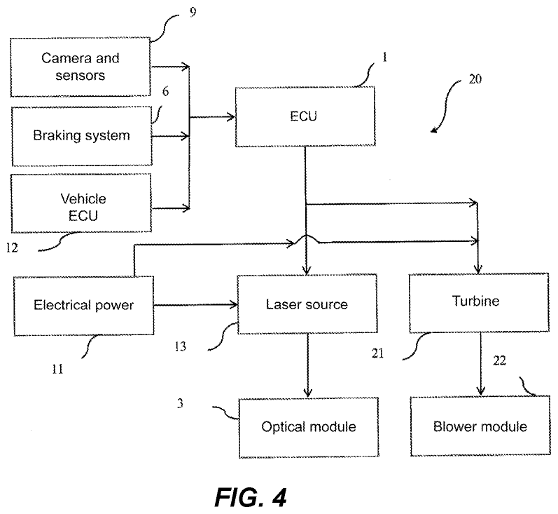

In a second embodiment illustrated by FIGS. 3 and 4, the grip optimization device 20 comprises, in addition to all the components of the first embodiment that has just been described with reference to FIGS. 1 and 2, a turbine 21 controlled by the control and processing unit (ECU) 1 and powered by the electrical energy unit 11, and a blower module 22 arranged inside the vehicle so as to be able to divert a portion of the water present in front of a tire fitted to this vehicle, this deflection effect being combined with an ablation effect of the water present in front of this rotating tire.

Of course, the present disclosure is not limited to the embodiments that have just been described and numerous other embodiments can be envisaged without departing from the scope of the present disclosure. In particular, the different components of the grip optimization device fitted to a motor vehicle can be arranged in locations other than those described in FIG. 2.

1. A device for improving grip of a tire fitted to a mobile vehicle traveling on a road surface, the device being on board the mobile vehicle and comprising:
means for detecting and characterizing the presence of a liquid on the road surface in front of the mobile vehicle,
means for processing information received from the detection and characterization means and for generating control instructions, and
means for emitting a power laser beam directed toward a portion of road surface in front of at least one tire fitted to the mobile vehicle, which means are designed to vaporize or sublimate the water present in front of the at least one tire in response to control instructions.

2. The device of claim 1, wherein the processing and control means are configured to further process information received from at least one braking safety system fitted to the mobile vehicle.

3. The of claim 2, wherein the detection and characterization means comprise a camera having an image-capture field directed toward a portion of road surface in front of the mobile vehicle.

4. The device of claim 3, wherein the detection and characterization means further comprise means for measuring or estimating an external temperature in a vicinity of the road surface.

5. The device of claim 1, wherein the means for emitting a laser beam comprise an optical laser module positioned under the mobile vehicle and arranged so as to project the laser beam onto a portion of road surface in front of a tire of the mobile vehicle.

6. The device of claim 5, wherein the means for emitting a laser beam further comprise a laser source module controlled by the processing and control means and connected to the optical module via optical fiber means.

7. The device of claim 5, wherein the optical laser module is configured to scan a laser beam over the road surface according to a predetermined scanning trajectory.

8. The device of claim 2, wherein the braking safety system comprises an anti-lock braking system.

9. The device of claim 2, wherein the braking safety system comprises an emergency braking system.

10. The device of claim 2, wherein the braking safety system comprises an electronic stability program.

11. The device of claim 1, wherein the control and processing means are connected to an electronic control unit of the mobile vehicle.

12. The device of claim 1, wherein the device is mounted to a vehicle comprising a body to which the means for emitting the laser beam are attached, wherein the device further comprises means for detecting movement of the body and for transmitting detection information to the control and processing means.

13. The device of claim 1, further comprising means for deflecting at least a portion off liquid water located in front of the at least one tire.

14. The device of claim 1, further comprising means for cooling at least one component of the device.

15. The device of claim 14, wherein the cooling means comprises a heat transfer fluid circuit.

16. The device of claim 14, wherein the cooling means of the device are independent of a cooling system of the mobile vehicle.

17. The device of claim 1, wherein the means for emitting a laser beam are further configured to create a plasma for diverting at least a portion of water present in front of the at least one tire.

18. The device of claim 17, wherein the means for emitting a laser beam are further configured to create a deflection shock wave.

19. A method for improving grip of a tire fitted to a mobile vehicle traveling on a road surface, implemented in a grip optimization device according to claim 1, the method comprising:
detecting and characterizing presence of water on the road surface in front of the mobile vehicle,
transmitting information for detecting and characterizing the presence of water on the road surface,
processing the detection and characterization information to generate control instructions, and
emitting a power laser beam directed toward a portion of road surface in front of at least one tire fitted to the mobile vehicle, so as to vaporize or sublimate the water present in front of the at least one tire in response to the control instructions.

20. The method of claim 19, further comprising processing information received from at least one braking safety system fitted to the mobile vehicle.

21. The method of claim 19, wherein the detection and characterization comprises using a camera having an image-capture field directed toward a portion of road surface in front of the mobile vehicle.

22. The method of claim 21, wherein the detection and characterization further comprises measuring or estimating an external temperature in a vicinity of the road surface.

23. A motor vehicle comprising:
a body including a front bumper;
at least one tire; and
a device for improving grip of the at least one tire to a road surface, the device including:
means for detecting and characterizing the presence of water on the road surface in front of the motor vehicle,
means for processing information received from the detection and characterization means and for generating control instructions, and
means for emitting a power laser beam directed toward a portion of the road surface in front of at least one tire fitted to the motor vehicle, the means for emitting the power laser beam being arranged in the front bumper of the motor vehicle.

24. The motor vehicle of claim 23, further comprising means for deflecting at least a portion of the liquid water located in front of the at least one tire.

25. An aircraft comprising:
a body;
landing gear including at least one tire; and
a device for improving grip of the at least one tire to an airstrip, the device including:
means for detecting and characterizing the presence of water on an airstrip in front of the aircraft when traveling on the airstrip,
means for processing information received from the detection and characterization means and for generating control instructions, and
means for emitting a power laser beam directed toward a portion of airstrip in front of at least one tire of the landing gear of the aircraft, the means for emitting the power laser beam being arranged on the landing gear.

26. The aircraft of claim 25, further comprising means for deflecting at least a portion of the liquid water located in front of the at least one tire.
